(19) United States
(12) Patent Application Publication
(10) Pub. No.: US 2013/0032042 A1
(43) Pub. Date: Feb. 7, 2013

(54) DEVICE FOR AGITATING LIQUID FOODSTUFF

(71) Applicant: Petrus Adrianus Johannes Maria Elissen, Laren (NL)

(72) Inventor: Petrus Adrianus Johannes Maria Elissen, Laren (NL)

(21) Appl. No.: 13/574,091

(22) PCT Filed: Sep. 20, 2010
(86) PCT No.: PCT/NL2010/050611

§ 371 Date: Oct. 12, 2012

(30) Foreign Application Priority Data
Jan. 19, 2010 (NL) 2004113

(51) Int. Cl. A47J 31/44

(52) U.S. Cl. 99/453; 99/460; 99/466

(57) ABSTRACT

The invention provides a device (100, 200, 300, 600) for agitating a liquid, e.g. a milk frother, comprising: a main body (110) comprising an opening (116) adapted to releasably receive an inner container (120), which inner container is suitable for receiving the liquid; an agitation element (136) for agitating the liquid when the liquid is received in the inner container and the inner container is received in the opening of the main body; a driving element (132) for driving the agitation element; and an electrical connection (154, 152, 111) for providing electrical energy to the driving element. By providing an opening for releasably receiving an inner container, a separate container can be used in conjunction with the device. This container is releasable, so it can be put in a dishwashing machine or a sink with water without any risk of damaging the electrical components of the device. In this way, the container can be easily, hygienically and conveniently be cleaned.

### FIELD OF THE INVENTION

The invention relates to a device for agitating liquid foodstuff. In particular, the invention relates to a device for frothing milk or milk-based liquids.

### BACKGROUND OF THE INVENTION

WO 2009/020384, Further referred to as D1, discloses a device for frothing milk. The device comprises a main body which forms a container. Additionally, the device comprises a cover fitting on the main body and agitation means and drive means for driving the agitation means. The driving means are at least partially comprised in the cover.

Milk, when heated, is known to stick to walls of a container in which it is heated, even when the inner wall of the container is clad with an anti-adhesive layer to prevent any heated liquid sticking to the wall of the container. In practice, such liquids appear in particular to adhere in or next to indicator elements provided in the container as recesses or protrusions. As the milk frother disclosed in D1 comprises electrical elements, care may be needed to clean the inside of the container. In particular, milk frothers generally cannot be put in a dishwashing machine for convenient cleaning.

### OBJECT AND SUMMARY OF THE INVENTION

It is an object of the invention to provide a device with improved user convenience, in particular with respect to cleaning.

In a first aspect, the invention provides a device (e.g. a milk frother or a device for frothing milk or milk-based liquids) for agitating a liquid, comprising a main body comprising an opening adapted to releasably receive an inner container, which inner container is suitable for receiving the liquid; an agitation element for agitating the liquid when the liquid is received in the inner container and the inner container is received in the opening of the main body; a driving element for driving the agitation element; and an electrical connection for providing electrical energy to the driving element.

By providing an opening for releasably receiving an inner container, a separate inner container can be used in conjunction with the device. This container is releasable, so it can be put in a dishwashing machine or submersed in a sink with water without any risk of damaging the electrical components of the device. In this way, the container can be easily, hygienically and conveniently be cleaned.

In an embodiment of the device according to the invention, the inner container comprises a handle and the device comprises a further opening at the side for receiving the handle. By providing the handle, the container can also be properly handled e.g. when comprising a hot liquid. If the container is primarily made out of a metal, like steel or aluminium, handling the container comprising a hot liquid without a handle can be a tedious job.

A further embodiment of the device according to the invention comprises at least one fixation element for fixating the inner container to the device upon receiving the container in the opening. While agitating the liquid in the container, the momentum of the liquid will at least partially be transferred to the container. If the container is loosely fitted in the opening of the device, this transfer of momentum may result in movement of the container. This, in turn, may result in spilling of the liquid and/or less effective agitation or frothing of the liquid or milk.

In a second aspect, the invention provides an inner container for containing a liquid e.g. like milk or a milk-based liquid to be used in conjunction with the device according to the invention.

An embodiment of the inner container according to the invention comprises at least one fixation element for fixating the container to the device upon receiving the container in the opening.

Another embodiment of the inner container according to the invention comprises an upper rim of which at least a portion extends beyond the upper level of the device when the container is received in the opening of the device.

As already discussed, care has to be taken for the electrical components of the device. As the inner container is to be received by the opening of the device, the boundary between the outer wall of the container and the inner wall of the device, i.e. the opening, may not always be properly sealed. In that case, there is a risk of liquid leaking into the opening of the device, potentially damaging the electrical—or other—elements of the device. By providing an at least partially extended upper rim of the device, this risk is reduced.

In a further embodiment of the inner container according to the invention, the upper rim of the container has an orientation of substantially 85°-95° or 90° to the sidewall of the container, pointing away from the container.

With this embodiment, the risk of leakage of liquid into the inner side of the device is even further reduced, because the rim extends beyond the boundary between the container and the wall of the opening in the device for receiving the container.

In a third aspect, the invention provides a system comprising the device according to the invention and the inner container according to the invention.

### BRIEF DESCRIPTION OF THE DRAWINGS

The invention will now be discussed referring to drawings. These drawings are provided to illustrate embodiments of the invention and are provided as examples rather than to limit the scope of the invention. In the drawings:

FIG. 1 shows an embodiment of the system according to the invention;

FIG. 2 shows a further embodiment of the system according to the invention;

FIG. 3 shows another embodiment of the system according to the invention;

FIG. 4 shows an embodiment of the container according to the invention;

FIG. 5 A shows a cross-section of a further embodiment of the container according to the invention;

FIG. 5 B shows a cross-section of another embodiment of the container according to the invention; and

FIG. 6 shows a cross-section of yet a further embodiment of the system according to the invention.

### DESCRIPTION OF PREFERRED EMBODIMENTS

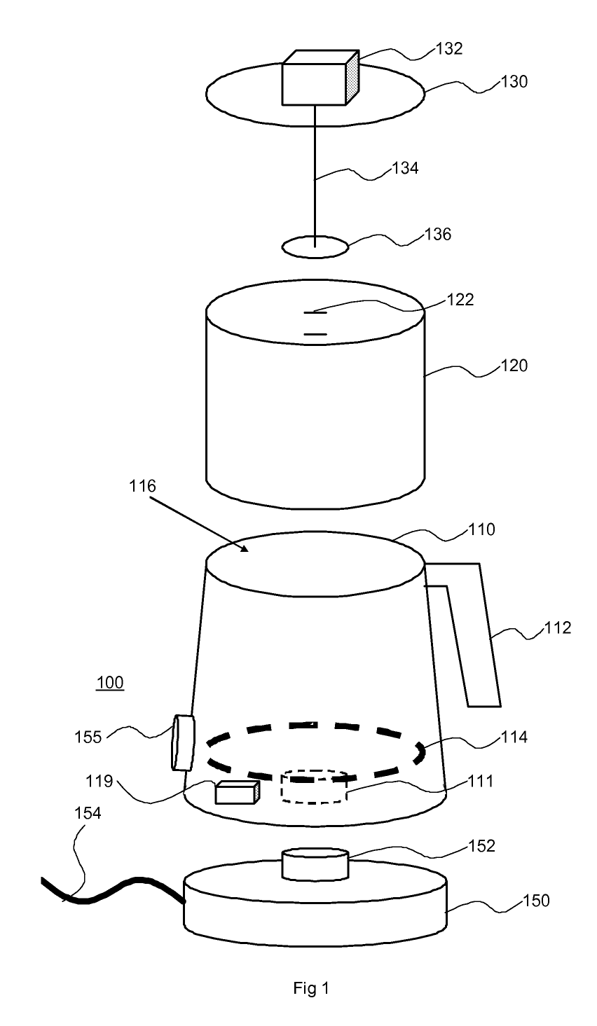

FIG. 1 discloses a device for agitating a liquid 100 in the preferred exemplary form of milk frother 100 as an embodiment of the device according to the invention. The device for agitating a liquid will be referred to as a device for frothing milk or milk-based liquids or a milk frother in the following. The milk frother comprises a main body 110, a base plate 150 and a lid or cover 130. In addition, FIG. 1 discloses an inner container 120.

The base plate 150 has an electrical power cord 154 connected thereto for powering the milk frother 100 and a contact stub 152 comprising electrical contacts for providing electrical power to the main body 110. Preferably, the contact stub 152 comprises three contacts, namely phase, zero and ground. The ground contact may be omitted, though is advised to be present for safety reasons.

The main body 110 may comprise a heating element 114, a handle 112, a microcontroller (119), a control knob (155) or buttons (not shown) and an opening 116 for receiving the container 120. In addition, the main body comprises a contact recess 111 for accommodating the contact stub 152. The contact recess 111 comprises the same number of contacts as present in the contact stub 152. Such contact/stub recess combinations are commercially available from the company Otter, with reference CS4 or CS7, among others. The heating element 114 is connectable to electrical power by means of electrical conductors like wires to the contacts in the contact recess 111. Additional electrical elements like an on/off switch, a control light like an LED and/or a thermostat may be placed in between the contacts in the contact recess 111 and the heating element 114.

The lid 130 comprises a driving element like a motor 132 connected to a shaft 134 for driving an agitation element 136, e.g. a circular annular spring or the like. The motor 132 is via conducting wires connected to the contacts in the contact recess 111. Additional elements like a transformer, rectifier, microcontroller, an on/off switch and other may be placed in between the contacts in the contact recess 111 and the motor 132. The lid 130 can be placed on the container 120 and on the main body 110, thus closing the opening 116.

To provide electrical power to the motor 136 in the lid 130, electrical contacts are provided at the top region of the main body and corresponding electrical contacts are provided in the lid 130. The electrical contacts provided at the top region of the main body are connected to the contacts in the contact recess 111. In a further embodiment, the motor receives electrical power from the main body 110 by means of an inductive coupling.

For proper contact between the electrical contacts on the main body 110 and the corresponding electrical contacts on the lid 130, the electrical contacts are to be aligned properly. Various elements can be added to either the main body 110 or the lid 130, or both. For example, protrusion can be applied to the first and a recess or groove to the other, or vice versa. The protrusion can be either pointwise or elongated. The protrusion can be applied in a vertical way, along the side of either the main body 110 or the lid 130, from the centre of the lid 130 or the main body 110 in a horizontal way or parallel to the circumference of either the main body 110 or the lid 130.

The container 120 may comprise indicator elements 122 for indicating a maximum level of liquid and a minimum level of liquid required for proper operation of the milk frother 100. The indicators can be provided as either protrusions or recesses in the inner wall of the container 120. The container 120 can be fit in the opening 116 in the main body 110. In operation, the bottom of the container 120 is located closely to or in contact with the heating element 114. In this way, liquids in the container 120—preferably milk or milk-based liquids—can be heated by means of the heating element 114.

The operation of the milk frother 100 is controlled by means of a microcontroller and a control knob or the like. The microcontroller is coupled to the control knob and to various actuators of the milk frother, (e.g. like the heating element) 114 and the motor 132, for controlling those actuators. With the control knob, a user of the milk frother 100 is able to control at least one action of the milk frother 100, like turning the motor 132 on or off, the rotation speed of the motor 132, turning the heating element 114 on or off, and/or setting a time for the motor 132 and/or the heating element 114 to be active. The control knob may be operated in steps or in a continuous way. One or more buttons (not shown) may also replace the control knob or be used in addition to it (e.g. for additional purposes).

The liquid is, e.g. while heated, agitated by means of the agitation element 136 e.g. like a circular annular spring 136, a wire whisk, or the like, thereby frothing the milk. Advantageously, the shaft 134 is placed outside the middle of the container 120, i.e. off-center. This is to prevent the whole of the liquid to spin around the centre of the container. Milk is frothed better with a turbulent movement.

The container 120 is insertable in and removable or detachable from the opening 116 in the main body 110. The container is e.g. loosely or tightly fit in the opening 116. Alternatively, the container 120 and the main body 110 are provided with one or more fixating elements to releasably fixate the container 120 in the opening 116. The fixating elements can be embodied in various ways.

Magnetic elements may e.g. be provided at the bottom of the opening 116, while the container 120 is made out of a ferro-magnetic material like steel. An advantage of this embodiment is that no fixating means need to be provided on the container 120. The container 120 may also be provided with a thread to screw the container in the opening 116. The thread may be provided at the outer circumference of the container 120. In this embodiment, a mating thread is provided at the inner circumference of the opening 116. Alternatively, a cylindrical stub with a thread is provided at the bottom (or elsewhere) of the container 120. In this embodiment, a cylindrical recess is provided at the bottom (or elsewhere) of the opening 116 with a mating thread.

In yet another embodiment, either the container 120 or the main body 110 is provided with at least one spring loaded protrusion and the other element—either the main body 110 or the container 120, respectively—is provided with at least one recess in which the spring loaded protrusion fits when the container 120 is fit in main body 110. The protrusions and/or spring loaded protrusion are provided at the sidewalls of the container 120 and/or the opening 116.

In a further embodiment, the container 120 can be fixated in the main body 110 by means of a bayonet closing. A bayonet closing usually comprises at least two protrusions on a first element and at least two L-shaped recesses or openings on a second element. Both elements are cylindrically shaped, where one element is fitted in the other element. The protrusions of the first element are fit in first legs of the L of the L-shaped recesses or openings with a pushing action and with a twisting action in second legs of the L-shaped recesses or openings. The bayonet closing may be provided with a spring. The purpose of the spring is to push the element fitted in the other out of the other while removing the element. The element is pushed out of the other when the protrusions are moved out of the second legs of the L-shaped recesses or openings.

Additionally or alternatively, the container 120 may be provided with at least one preferably vertical recess in the outer wall and the wall of the opening 116 may be provided with a protrusion fitting in said recess or vice versa. The recess or recesses and the protrusion or protrusions enable improved guidance while inserting the container 120 in the main body 110. This embodiment is particularly advantageous when the container 120 is to be inserted in the main body 110 with a specific orientation. The recesses may also be embodied as grooves or slits, where applicable. With these embodiments, the container 120 is slid into the opening 116 in the main body.

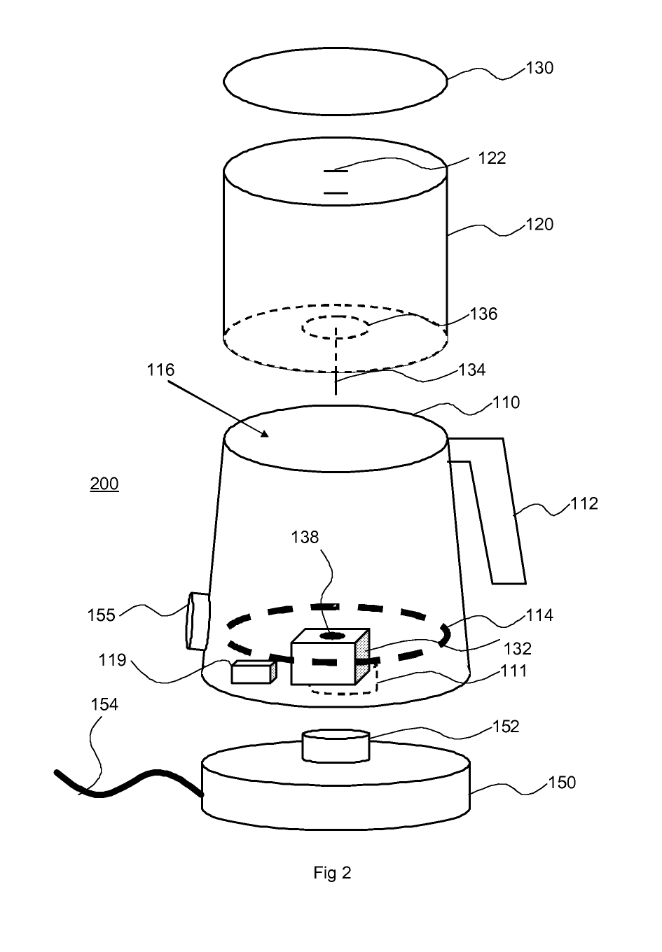

FIG. 2 discloses a milk frother 200 as another embodiment of the device according to the invention. The milk frother 200 comprises a main body 110, a base plate 150 and a lid or cover 130. In addition, FIG. 2 discloses a container 120.

The base plate 150 has an electrical power cord 154 connected thereto for powering the milk frother 100 and a contact stub 152 comprising electrical contacts for providing electrical power to the main body 110. Preferably, the contact stub 152 comprises three contacts, namely phase, zero and ground. The ground contact may be omitted, though is advised to be present for safety reasons.

The main body 110 may comprise a heating element 114, a handle 112 and an opening 116 for receiving the container 120. In addition, the main body comprises a contact recess 111 for accommodating the contact stub 152. The contact recess 111 comprises the same number of contacts as present in the contact stub 152. Such contact/stub recess combinations are commercially available from the company Otter, with reference CS4 or CS7, among others. The heating element 114 is connectable to electrical power by means of electrical conductors like wires to the contacts in the contact recess 111. Additional electrical elements like an on/off switch, a control light like an LED and/or a thermostat may be placed in between the contacts in the contact recess 111 and the heating element 114.

The main body also comprises a motor 132 that in this embodiment is placed at the bottom or lower part of the milk frother instead of in the lid as in FIG. 1. The motor 132 is electrically connected to the contacts in the contact recess 111, for example. Additional elements like a transformer, rectifier, microcontroller, an on/off switch and other may be electrically connected to the contacts in the contact recess 111 and the motor 132, for example by means of conducting wires. The motor 132 is connected to a mechanical connector 138 to connect to a shaft 134 for driving an agitation element 136 e.g. in the form of a circular annular spring, a wire whisk, or the like comprised within the container 120.

The shaft 134 is fit in an opening in the container 120 to enable the agitation element to be driven. When removing the container, the shaft 134 is removed from the mechanical connector 138. Optionally, the shaft 134 can be removed from the container 120 for the purpose of cleaning the container 120 and/or the shaft 134. Preferably, the opening in the container 120 through which the shaft 134 during operation is provided is well sealed when the shaft 134 is in place. This can be done by means of an O-ring of either natural or synthetic rubber, like silicon rubber, or other flexible materials. Proper sealing of the opening is important to avoid leakage of liquid from the container to the inner parts of the main body 110 to prevent for example damage to the electronic circuitry.

In a further embodiment, the agitation element 136 is connected to the motor 132 by means of a magnetic coupling. To this end, a hollow and at the upper side closed protrusion is provided at the bottom of the container 120. From the bottom, a shaft with magnets—either permanent or electrical—are provided, which shaft is connected to the motor 132. The agitation element 136 is also provided with magnets, which are in use coupled to the magnets connected to the shaft that is connected to the motor 132. In this way, operation of the motor results in driving the agitation element 136.

The container 120 can be fixated in the opening 116 of the main body 120 in various ways, as discussed before. The lid 130 fits on the top of the container 120 and the opening 116.

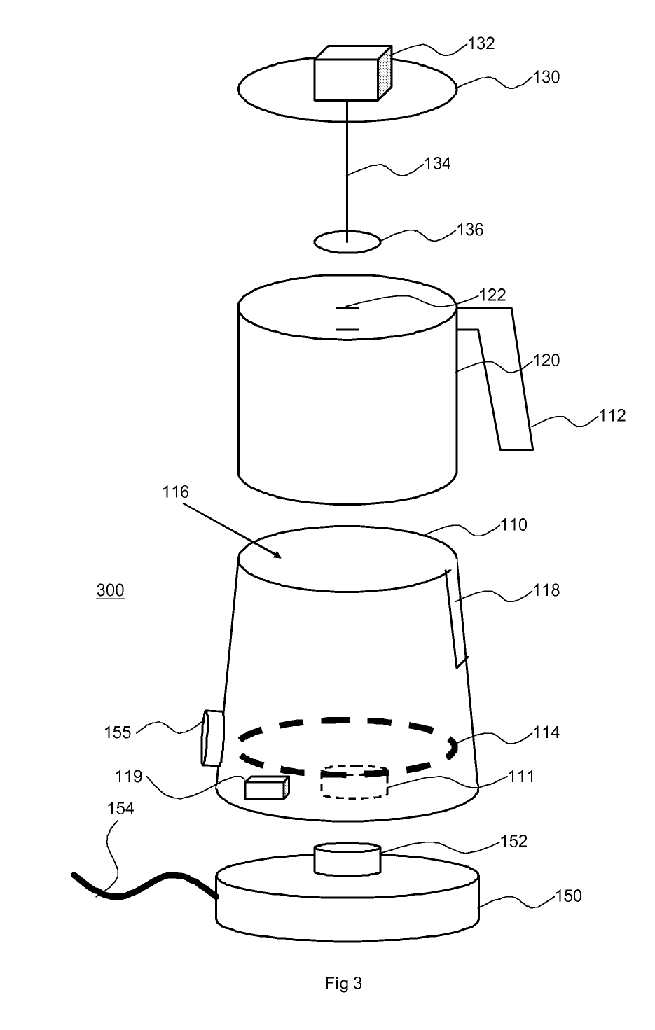

FIG. 3 discloses a milk frother 300 as a further embodiment of the device according to the invention. The milk frother 200 comprises a main body 110, a base plate 150 and a lid or cover 130. In addition, FIG. 3 discloses a container 120.

The base plate 150 has an electrical power cord 154 connected thereto for powering the milk frother 100 and a contact stub 152 comprising electrical contacts for providing electrical power to the main body 110. Preferably, the contact stub 152 comprises three contacts, namely phase, zero and ground. The ground contact may be omitted, though is advised to be present for safety reasons.

The main body 110 comprises an optional heating element 114 and an opening 116 for receiving the container 120. In addition, the main body comprises a contact recess 111 for accommodating the contact stub 152. The contact recess 111 comprises the same number of contacts as present in the contact stub 152. Such contact/stub recess combinations are commercially available from the company Otter, with reference CS4 or CS7, among others. The heating element 114 is connectable to electrical power by means of electrical conductors like wires to the contacts in the contact recess 111. Additional electrical elements like an on/off switch, a control light like an LED and/or a thermostat may be electrically coupled to the contacts in the contact recess 111 and the heating element 114, for example by means of electrical wires.

The lid 130 comprises a motor 132 connected to a shaft 134 for driving an agitation element 136 e.g. a circular annular spring, a whisk, or the like. The motor 132 is electrically connected to the contacts in the contact recess 111, for example via conducting wires. Additional elements like a transformer, rectifier, microcontroller, an on/off switch and other may be electrically contacted to each other and/or the contacts in the contact recess 111 and the motor 132. The lid 130 can be placed on the container 120 and on the main body 110, thus closing the opening 116. In a further embodiment, the motor receives electrical power from the main body 110 by means of an inductive coupling.

Electrical power to the motor 132 in the lid may be provided as described earlier.

The container 120 is insertable in and removable or detachable from the opening 116 in the main body 110. The container may be loosely or tightly fitted in the opening 116. Alternatively, the container 120 and the main body 110 are provided with fixating element to releasably fixate the container 120 in the opening 116. The fixating elements can be embodied in various ways as discussed before.

The container 120 comprises a handle 112 for easily removing the container 120 from the main body 110. In the embodiment as disclosed on FIG. 3, the handle 112 is connected to the sidewall of the container 120. To properly accommodate the container 120 in the main body 110, a slit, opening or the like 118 is provided at the top of the sidewall of the main body 110. Alternatively, the handle 112 is attached at the top of the container 120. In that way, no slit, opening, etc. has to be provided in the main body 110. It will be apparent to a person skilled in the art that a handle connected to the container 120 does not necessarily have to be shaped as disclosed in FIG. 3. Alternatively, a half-circle handle connected to opposite sides of the upper rim of the container 120, enabling the container 120 to be carried as a basket or a bucket.

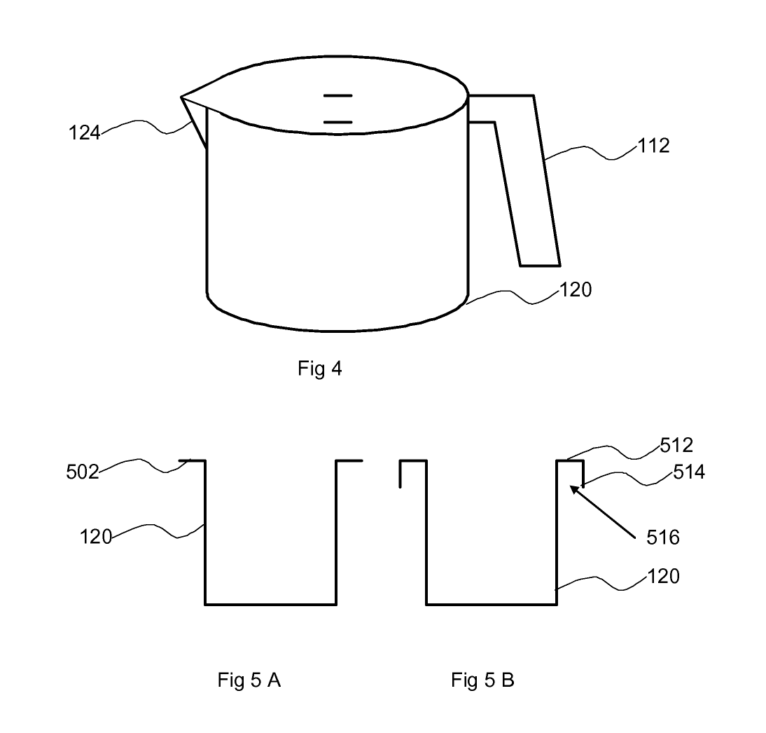

FIG. 4 shows a container 120 as another embodiment of the container according to the invention. The container 120 comprises a handle 112 and a pouring spout 124 at the upper rim of the container 120. The pouring spout 124 facilitates pouring a heated and/or mixed liquid like frothed milk. In addition, the pouring spout 124 prevents leakage of liquid from the container 120 in the opening 116 of the main body 110 (see e.g. FIGS. 1 □3) after the contents of the container 120 has been poured in another container like a coffee cup. Drips—if any—will remain at the tip of the spout, which will not overlap with the opening 116 (FIG. 1).

The container 120 has been disclosed having a flat horizontal bottom and a cylindrical wall substantially vertically positioned on the flat bottom. The inventor has appreciated that this provides a container that is difficult to empty, in particular in the corners between the wall and the bottom. To address this issue, the container 120 may also by provided with a concave bottom instead of a flat bottom, i.e. a bottom that is deeper in the middle than at the sides. The concave form of the bottom may be further implemented by having a spherical, elliptical, oval, parabolic or other concave form.

Additionally or alternatively, the cylindrical wall of the container is not substantially vertical, but provides a larger diameter at the top of the container 120 than at the bottom of the container 120. This makes the angle between the bottom of the container and the wall of the container less sharp, making emptying or cleaning the container more convenient.

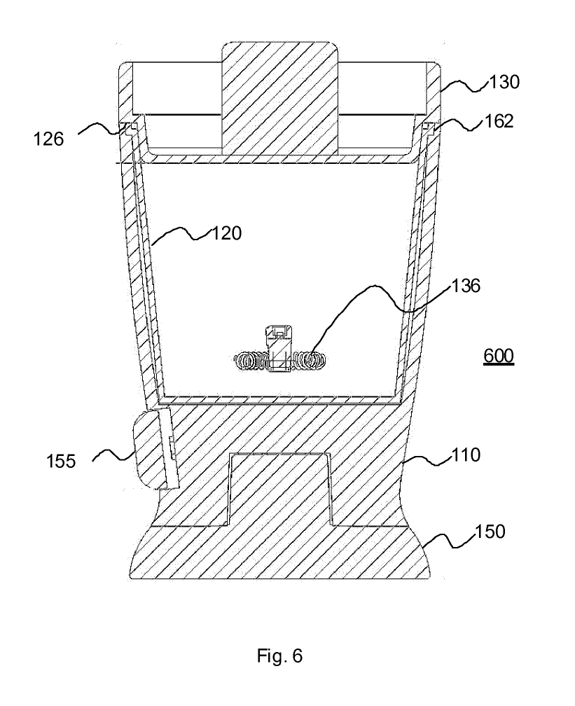

FIG. 5 A shows a cross-section of a container 120 comprising an extended upper rim 502 with an orientation of about 90° to the sidewall of the container 120. The upper rim prevents or at least reduces the risk of leakage of liquid from the container in the opening 116 of the main body (see e.g. FIGS. 1 □3). It is to be understood that the rims 512, 514 may be curved partially or fully. Furthermore, the orientation angle may be different than about 90° to the sidewall of the container 120, e.g. between about 85°—about 95° or other angles.

FIG. 5 B shows a cross-section of a container 120 comprising an extended upper rim 512 connected to an outer rim 514. The outer rim 514 and the outer wall of the container 120 form a cavity 516. When the container 120 is fit in the opening 116 of the main body 110 (see e.g. FIGS. 1 □3), the upper rim of the main body 110 fits in the cavity 516. In this way, the risk of leakage of liquid from the container in the opening 116 of the main body 110 is even further reduced than with the solution discussed in accordance with FIG. 5 A.

In again another embodiment of the device according to the invention that will be discussed referring to FIG. 1, the top of the circumference of the opening 116 is provided with a lining or a sealing element comprising a flexible material like silicon rubber, natural rubber, or similar to seal any potential opening between the outer wall of the container 120 and the inner wall of the main body 110 at the location of the opening 116. Alternatively, the lining is provided at the top of the outer wall of the container 120. In another alternative, referring to FIG. 5 B, the lining is provided in the cavity 516. In yet another alternative, the lining is provided at a lower portion of either the opening 116 or the container 120.

The rims disclosed in FIG. 5 A and FIG. 5 B may also serve for connecting a handle to the container. In such embodiments, the further opening 118 would be superfluous and can therefore be omitted.

FIG. 6 discloses a milk frother 600 as yet another embodiment of the device according to the invention. The milk frother 600 comprises a main body 110, a base plate 150 and a lid or cover 130. In addition, FIG. 6 discloses a container 120. The container 120 comprises an outstanding rim 126 at the top of the container.

The main body has a control knob 155 attached to it for controlling the operation of the milk frother 600 as described with another embodiment of the device according to the invention.

The container 120 is fitted in the main body 110. The outstanding rim 126 of the container 120 fits in a circular recess 162 at the top of the opening of the main body 110, thus providing a closed fit between the container 120 and the main body 110. In this way, any liquid is prevented from entering the main body 110 where such liquid can jeopardise the operations of the milk frother 600, in particular by potential damage to electrical circuitry of the milk frother 600.

The lid 130 has a lower closing part having an outer diameter that is substantially equal to the inner diameter of an upper part of the container 120. In this way, the lid 130 is fitted in the container 120 rather than fitted on the main body 110. In this way, the container 120 can be lifted out of the main body 110 by picking up the lid 130. This eliminates the need for a handle being attached to the container 120. Additionally, there is no risk of spilling any liquid from the container 120 into the main body 110. Alternatively, the lid 130 is fitted on the main body 110 and protruding in the container 120.

The lid 130 can be connected to the container 120 in various ways. For example, either the lid 130 and/or the upper part of the container 120 are provided with a flexible O-ring. By putting the lid 130 on the container 130, the O-ring is squeezed between the lid 130 and the container 120, thus increasing the friction force between the lid 130 and the container. By means of this friction force, the container 120 can be lifted out of the main body 110. Subsequently, the container can be put somewhere with the lid 130 closing the container.

Alternatively, the lid 130 is connected to the container 120 by other means, including the means discussed as alternatives for connecting the container 120 to the main body 110 for other embodiments of the device according to the invention, including, but not limited to bayonet fittings, spring loaded protrusions in for example the lid 130 fitting in recesses in the container 120 and magnetic coupling. In addition to these means, an additional sealing element like a flexible O-ring may be provided.

With respect to functional elements, variations as discussed before apply to the milk frother 600 as well. This e.g. applies to the location of the electromotor and other elements. This means that the circular annular spring 136 can be driven by an electromotor or other driving means located in either the lid 130 or the main body 110. As discussed before, the circular annular spring 136 may be replaced by a conventional wire whisk or other agitation means.

While referring to a container, it is noted that, unless otherwise clearly apparent from the context, an inner container for use with for example but not limited to a device for frothing milk or other liquids is meant. Such container is to be understood to be a container or inner container that fits within a main body of the device for whipping or agitating liquids in a way that the outer perimeter or at least part thereof like the upper rim fits closely and preferably tightly with the inner wall of the main body and in particular the wall of an opening in the main body arranged for receiving the container.

Though steel and aluminium have been disclosed as materials for the container 120, a person skilled in the art will appreciate that also other metals or even materials other than steel may be used.

Referring to FIG. 1 through FIG. 3 and FIG. 6, alternatively, the base plate 150 and the contact recess 111 may be omitted, while connecting the power cord 154 directly to the main body 110 for supplying electrical energy. In particular with the removable inner container 120, there is at least less need for the main body to be cordless for convenient handling.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa. When data is being referred to as audiovisual data, it can represent audio only, video only or still pictures only or a combination thereof, unless specifically indicated otherwise in the description of the embodiments.

In the description above, it will be understood that when an element such as layer, region or substrate is referred to as being on or onto another element, the element is either directly on the other element, or intervening elements may also be present.

Furthermore, the invention may also be embodied with less components than provided in the embodiments described here, wherein one component carries out multiple functions. Just as well may the invention be embodied using more elements than depicted in FIG. 1 through 6, wherein functions carried out by one component in the embodiment provided are distributed over multiple components.

A person skilled in the art will readily appreciate that various parameters disclosed in the description may be modified and that various embodiments disclosed and/or claimed may be combined without departing from the scope of the invention. It is stipulated that the reference signs in the claims do not limit the scope of the claims, but are merely inserted to enhance the legibility of the claims.

1-18. (canceled)

19. A milk frothing device for frothing a liquid being milk or a milk-based liquid, comprising:
a main body and a removable inner container for receiving the liquid, wherein the main body comprises an opening adapted to releasably receive the inner container, wherein the inner container is primarily made out of metal, e.g. like steel or aluminum, and fits within the main body,
an agitation element for frothing the liquid when the liquid is received in the inner container and the inner container is received in the opening of the main body,
a driving element for driving the agitation element,
an electrical connection for providing electrical energy to the driving element, and
a cover adapted to cover the inner container when the inner container is received by the main body and wherein the driving element is comprised by the cover.

20. The device according to claim 19, where the inner container comprises a handle.

21. The device according to any one of claim 19, wherein the inner container is received substantially fully in the main body.

22. The device as claimed in any one of claim 19, comprising a heating element for heating the liquid.

23. The device as claimed in any one of claim 19, wherein the agitation element is enabled to froth the liquid by means of a rotating movement.

24. The device as claimed in any one of claim 19, wherein the agitation element comprises a circular annular spring and/or a wire whisk.

25. The device as claimed in claim 19, wherein the driving element is an electromotor (132).

26. The device as claimed in claim 20, wherein the device comprises a further opening at the side for receiving the handle of the inner container when fitted in the opening.

27. The device as claimed in claim 21, wherein the further opening is a slit.

28. The device as claimed in claim 19, wherein a sealing element is provided around the opening.

29. The device as claimed in claim 25, further comprising at least one fixation element for fixating the container to the device upon receiving the container in the opening.

30. The device as claimed in claim 29, wherein the fixation element is at least one of the following:
a) a magnetic coupling;
b) a first thread for screwing in a mating second thread;
c) a recess for accommodating a spring or a spring-loaded element;
d) a spring or a spring-loaded element;
e) an L-shaped recess or opening for accommodating a protrusion constituting a bayonet closing;
f) a protrusion usable in conjunction with an L-shaped recess or opening constituting a bayonet closing.

31. The device as claimed in claim 19, wherein the cover comprises a closing part having an outer diameter substantially equal to the inner diameter of an upper part of the container thus closing the container if fitted on the container.

32. The device as claimed in claim 19, wherein the inner container has an exterior wall arranged to fit closely in the opening of the main body for at least a part of the exterior wall.

33. The device as claimed in claim 19, wherein the inner container comprises an upper rim of which at least a portion extends beyond the upper level of the device when the inner container is received in the opening of the device.

34. The device as claimed in claim 33, wherein the upper rim of the inner container comprises a pouring spout.

35. The device as claimed in claim 33, wherein the upper rim of the inner container has an orientation of substantially 90° or substantially 85°-95° to the sidewall of the container and points away from the centre of the inner container.

36. The device as claimed in claim 19, wherein the inner container has a concave bottom.
